(19) United States
(12) Patent Application Publication
(10) Pub. No.: US 2018/0236946 A1
(43) Pub. Date: Aug. 23, 2018

(54) CROSSBAR OF VEHICLE ROOF RACK

(71) Applicant: KING ROOF INDUSTRIAL CO., LTD., Taichung City (TW)

(72) Inventor: Shih-Chieh SHEN, Taichung City (TW)

(21) Appl. No.: 15/812,631

(22) Filed: Nov. 14, 2017

(30) Foreign Application Priority Data
Feb. 17, 2017 (TW) 106202273

(51) Int. Cl. B60R 9/058

(52) U.S. Cl. CPC B60R 9/058

(57) ABSTRACT

A crossbar of a vehicle roof rack is provided for being arranged on a car roof, and the crossbar of a vehicle roof rack includes a bar member and two strips. The bar member defines a longitudinal direction and includes a slide slot and two engagement slots which extend along the longitudinal direction, and the two engagement slots are formed on two sides of the slide slot and parallel to the slide slot. Each of the two strips includes an engaging portion which is connected to one of the two strips, each of the two engaging portions is engaged within one of the two engagement slots, and the two strips extend relative to each other and cover the slide slot.

### BACKGROUND OF THE INVENTION

### Field of the Invention

The present invention relates to a crossbar of a vehicle roof rack.

### Description of the Prior Art

Considering ways of transportation, a car has a great transporting function and can shield people from the environments outside, but as cars are massively produced due to commercialization and as people have greater demand for outdoor activities, the storage space (for example, the trunk) of the car cannot satisfy people's demand anymore, so people starts to develop and use the large area on the car roof to store things. Therefore, there are various types of car roof racks showing up on the market, the car roof rack has at least one crossbar, and a bicycle rack or a storage box is assembled on a fixing member of the crossbar of the vehicle roof rack rack so as to stably place a bicycle or a luggage on the car roof. This type of car roof rack is disclosed in TWI511894.

However, in this type of conventional car roof rack, the fixing member is slidably arranged in a slide slot of the crossbar, to prevent a wind shear sound from happening when the car is driven in a high speed, a rubber strip is engaged within the slide slot, and when a user wants to change relative positions of the fixing member and the crossbar, s/he has to cut the rubber strip so as to adjust the fixing member to the position s/he wants. By doing so, the rubber strip is choppy and has a broken appearance, and when it rains, rain may pond in the slide slot and rust the slide slot.

The present invention has arisen to mitigate and/or obviate the afore-described disadvantages.

### SUMMARY OF THE INVENTION

The major object of the present invention is to provide a crossbar of a vehicle roof rack which has a fixing member, and it is convenient for a user to adjust a position of the fixing member relative to the crossbar without cutting a rubber strip, so the rubber strip can be kept integral.

To achieve the above and other objects, a crossbar of a vehicle roof rack is provided for being arranged on a car roof, and the crossbar of a vehicle roof rack includes a bar member and two strips. The bar member defines a longitudinal direction and includes a slide slot and two engagement slots which extend along the longitudinal direction, and the two engagement slots are formed on two sides of the slide slot and parallel to the slide slot. Each of the two strips includes an engaging portion which is connected to one of the two strips, each of the two engaging portions is engaged within one of the two engagement slots, and the two strips extend relative to each other and cover the slide slot.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a partially-enlarged view of FIG. 1;

FIG. 3 is a breakdown view of the preferred embodiment of the present invention;

FIG. 4 is a partial stereogram of the preferred embodiment of the present invention;

FIG. 5 is a partially-enlarged view of the preferred embodiment of the present invention;

FIG. 6 is a cross-sectional view of the preferred embodiment of the present invention; and

FIG. 7 is an assembly view of the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

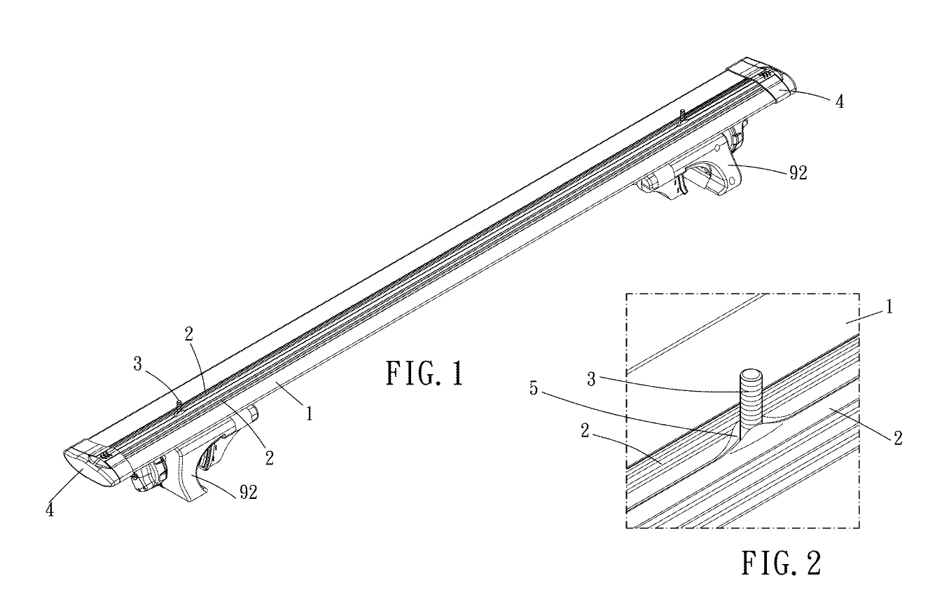

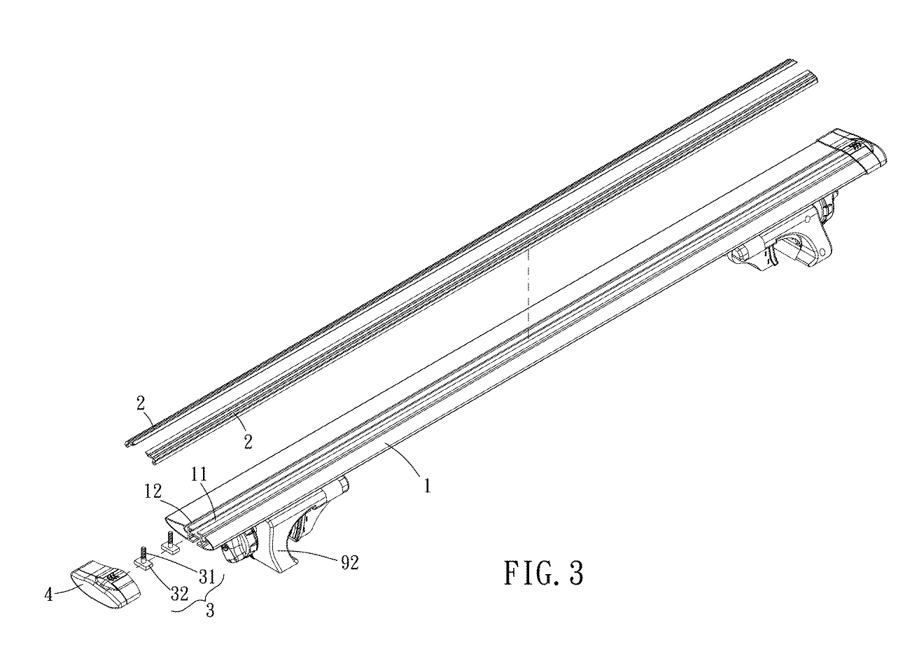

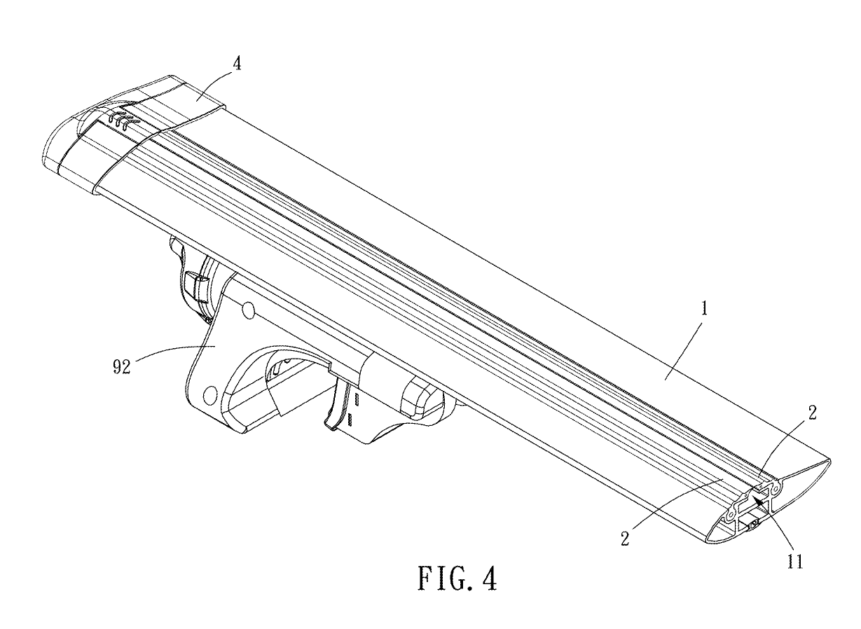

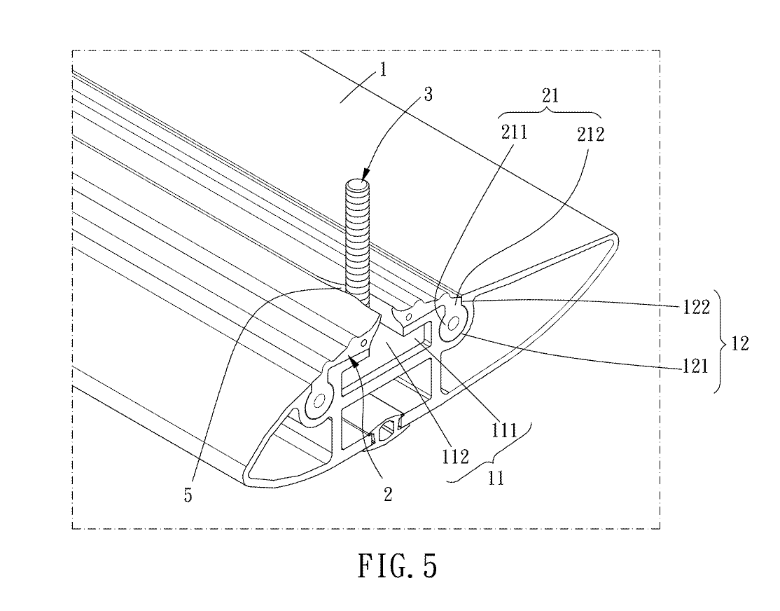

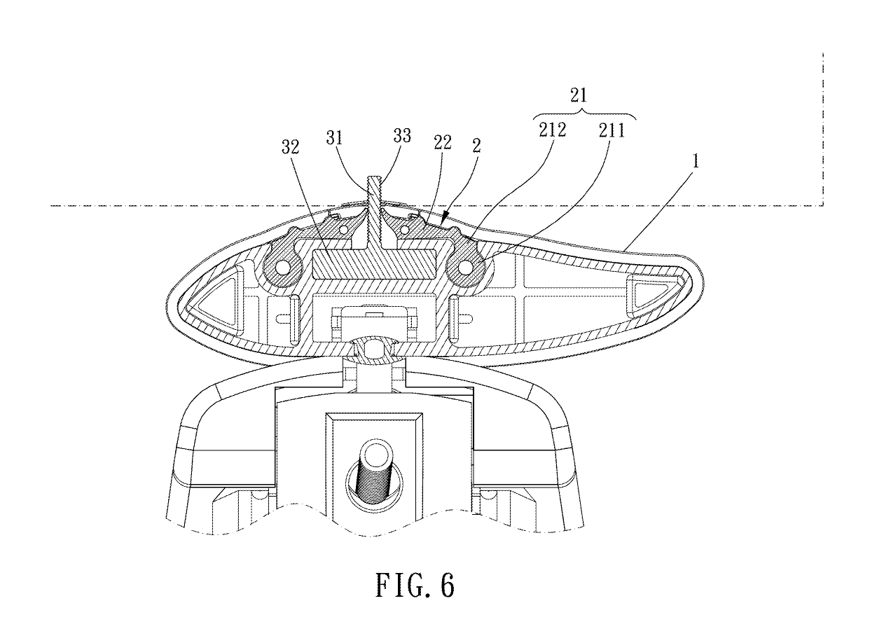

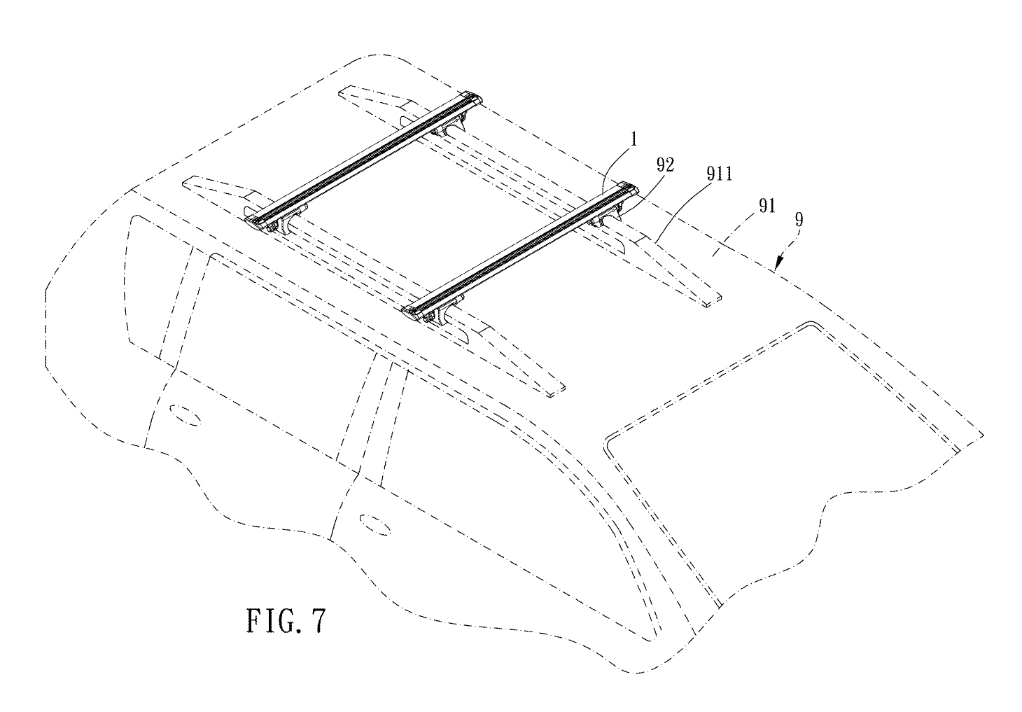

Please refer to FIGS. 1 to 7 for a preferred embodiment of the preset invention. A crossbar of a vehicle roof rack is provided for being arranged on a car roof 91 of a car 9, and the crossbar of the vehicle roof rack includes a bar member 1 and two strips 2.

The bar member 1 defines a longitudinal direction and includes a slide slot 11 and two engagement slots 12 which extend along the longitudinal direction, the two engagement slots 12 are formed on two sides of the slide slot 11 and parallel to the slide slot 11, preferably, the two engagement slots 12 may be round as disclosed in the Figs., and the two engagement slots may also be in elliptic or rectangular. In this embodiment, one of the two sides of the bar member 1 facing the car roof 91 further has two clamping seats 92, the two clamping seats 92 are for clamping two straight bars 911 near the car roof 91, and in other embodiments, the two clamping seats 92 may also respectively clamp two door frames near the car roof 91. Preferably, the bar member 1 is an extruded member (for example, formed by extrusion from aluminum) and integrally formed with the slide slot 11 and the two engagement slots 12 so that a manufacturing cost can be largely decreased.

Each of the two strips 2 includes an engaging portion 21 which is connected to one of the two strips 2, each of the two engaging portions 21 is engaged within one of the two engagement slots 12, and the two strips 2 extend relative to each other and cover the slide slot 11. Preferably, each of the two strips 2 is a flexible rubber strip or a flexible plastic strip, and in this embodiment, each of the two strips 2 is the flexible rubber strip.

In this embodiment, the two engaging portions 21 respectively extend to form an extension section 22, the slide slot 11 has a guide slot 112, and the two extension sections 22 cover the guide slot 112 of the slide slot 11.

The crossbar of the vehicle roof rack further includes at least one fixing member 3, each said fixing member 3 is slidably arranged within the slide slot 11 and includes a fixing portion 31, the fixing portion 31 protrudes beyond the guide slot 112 and abuts against the two extension sections 22, the two extension sections 22 have a gap 5 therebetween to allow the fixing portion 31 to protrude beyond the two extension sections 22, and each said fixing portion 31 is for being assembled to an object (for example, a car roof box or a bicycle rack on a car roof). Because the fixing member 3 protrudes beyond the two extension sections 22, the two extension sections 22 normally abut against a lateral face of the fixing portion 31 to positionably restrict the fixing member 3 to prevent the fixing member 3 from sliding randomly relative to the slide slot 11. If a user wants to adjust relative positions of the fixing member 3 and the slide slot 11, s/he only needs to apply force on the fixing member 3 to make the fixing member 3 detach from a restriction of the two extension sections 22 to move the fixing member 3. Therefore, with the crossbar of the vehicle roof rack, the user can positionably restrict and adjust the fixing member 3 without cutting the two strips 2, so the two strips 2 can be kept integral, and the slide slot 11 can be prevented from ponding.

Specifically, the fixing member 3 includes a slidable block 32 which is connected to the fixing portion 31, the slidable block 32 is non-circular and is non-rotatably and slidably arranged within the slide slot 11, in this embodiment, the slidable block 32 is a rectangular block, and the fixing portion 31 has a threaded portion 33 for being assembled to the object.

More specifically, in a cross-section of the bar member 1 as viewed in a direction lateral to the longitudinal direction, the slide slot 11 has a radially-enlarged section 111 and the guide slot 112 which has a relatively smaller diameter than the radially-enlarged section 111, the radially-enlarged section 111 and the guide slot 112 form a T shape, and the slidable block 32 is slidably arranged within the radially-enlarged section 111; therefore, the slidable block 32 cannot detach from the guide slot 112 so as to prevent the fixing member 3 from detaching from the slide slot 11 randomly. The slide slot 11 and the two engagement slots 12 penetrate the bar member 1, each said fixing member 3 can be assembled to the slide slot 11 from two ends of the bar member 1, the two ends of the bar member 1 are respectively covered by a cover 4 which is detachable, and the two covers 4 cover two ends of the slide slot 11 and two ends of the two engagement slots 12 so as to prevent each said fixing member 3 from sliding out from the two ends of the bar member 1.

Each of the two engaging portions 21 includes a head portion 211 and a neck portion 212 which has a relatively smaller diameter than the head portion 211, the neck portion 212 is connected to and between the head portion 211 and the extension section 22, each of the two head portions 211 is engaged with an expanded portion 121 of one of the two engagement slots 12, and each of the two neck portions 212 is located in a narrowed section 122 of one of the two engagement slots 12 to prevent the engaging portion 21 from detaching from the engagement slot 12 randomly. Each of the two extension sections 22 bends and extends from one of the two neck portions 212 to the slide slot 11 so that each of the two extension sections 22 normally covers the guide slot 112 and to positionably restrict each said fixing member 3.

Given the above, in the crossbar of the vehicle roof rack, the user can positionably restrict and adjust the fixing member without cutting the two strips, so the two strips can be kept integral, and the slide slot can be prevented from ponding.

While we have shown and described various embodiments in accordance with the present invention, it should be clear to those skilled in the art that further embodiments may be made without departing from the scope of the present invention.

What is claimed is:

1. A crossbar of a vehicle roof rack, for being arranged on a car roof, including:
a bar member, defining a longitudinal direction, including a slide slot and two engagement slots which extend along the longitudinal direction, the two engagement slots being formed on two sides of the slide slot and parallel to the slide slot;
two strips, each of the two strips including an engaging portion which is connected to one of the two strips, each of the two engaging portions being engaged within one of the two engagement slots, the two strips extending relative to each other and covering the slide slot.

2. The crossbar of the vehicle roof rack of claim 1, wherein the two engaging portions respectively extend to form an extension section, the slide slot has a guide slot, and the two extension sections cover the guide slot of the slide slot.

3. The crossbar of the vehicle roof rack of claim 2, further including at least one fixing member, each said fixing member being slidably arranged within the slide slot and including a fixing portion, the fixing portion protruding beyond the guide slot and abutting against the two extension sections, the two extension sections having a gap therebetween to allow the fixing portion to protrude beyond the two extension sections.

4. The crossbar of the vehicle roof rack of claim 3, wherein the fixing member includes a slidable block which is connected to the fixing portion, the slidable block is non-circular and is non-rotatably and slidably arranged within the slide slot, and the fixing portion has a threaded portion.

5. The crossbar of the vehicle roof rack of claim 4, wherein in a cross-section of the bar member as viewed in a direction lateral to the longitudinal direction, the slide slot has a radially-enlarged section and the guide slot which has a relatively smaller diameter than the radially-enlarged section, the radially-enlarged section and the guide slot form a T shape, and the slidable block is slidably arranged within the radially-enlarged section.

6. The crossbar of the vehicle roof rack of claim 2, wherein the slide slot and the two engagement slots penetrate the bar member, two ends of the bar member are respectively covered by a cover which is detachable, and the two covers cover two ends of the slide slot and two ends of the two engagement slots.

7. The crossbar of the vehicle roof rack of claim 2, wherein each of the two engaging portions includes a head portion and a neck portion which has a relatively smaller diameter than the head portion, the neck portion is connected to and between the head portion and the extension section, each of the two head portions is engaged with an expanded portion of one of the two engagement slots, and each of the two neck portions is located in a narrowed section of one of the two engagement slots.

8. The crossbar of the vehicle roof rack of claim 7, wherein each of the two extension sections bends and extends from one of the two neck portions to the slide slot.

9. The crossbar of the vehicle roof rack of claim 2, wherein each of the two strips is a flexible rubber strip or a flexible plastic strip.

10. The crossbar of the vehicle roof rack of claim 2, wherein the bar member is an extruded member and integrally formed with the slide slot and the two engagement slots.

11. The crossbar of the vehicle roof rack of claim 5, wherein the slide slot and the two engagement slots penetrate the bar member, two ends of the bar member are respectively covered by a cover which is detachable, and the two covers cover two ends of the slide slot and two ends of the two engagement slots; each of the two engaging portions includes a head portion and a neck portion which has a relatively smaller diameter than the head portion, the neck portion is connected to and between the head portion and the extension section, each of the two head portions is engaged with an expanded portion of one of the two engagement slots, and each of the two neck portions is located in a narrowed section of one of the two engagement slots; each of the two extension sections bends and extends from one of the two neck portions to the slide slot; each of the two strips is a flexible rubber strip or a flexible plastic strip; the bar member is an extruded member and integrally formed with the slide slot and the two engagement slots.
